(19) United States
(12) Patent Application Publication
(10) Pub. No.: US 2006/0164400 A1
(43) Pub. Date: Jul. 27, 2006

(54) Touch pad module

(75) Inventors: Chen-Ming Sun, Taipei (TW); Yi-Kuan Lin, Taipei (TW); Chin-Pin Chen, Taipei (TW); Tzu-Wei Lin, Taipei (TW); Jui-Yi Lin, Taipei (TW); Chien-Hung Su, Taipei (TW); Po-Ching Huang, Taipei (TW); Wen-Tsung Huang, Taipei (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: ASUSTeK Computer, Inc.

(21) Appl. No.: 11/304,478

(22) Filed: Dec. 15, 2005

(30) Foreign Application Priority Data
Jan. 27, 2005 (TW) 94102528

(51) Int. Cl. G09G 5/00

(52) U.S. Cl. 345/173

(57) ABSTRACT

A touch pad module of a computer has a metal click plate to control its operation system. A plastic member is attached under the metal click plate to provide a suitable and comfortable click action. The plastic has a frame portion and two button portions. Two button portions are respectively connected with the frame portion by a rib and a suspension arm. The suspension has an U-shaped spring to provide a proper elastic force when it is bent by a click action.

### RELATED APPLICATIONS

The present application is based on, and claims priority from, Taiwan Application Serial Number 94102528, filed Jan. 27, 2005, the disclosure of which is hereby incorporated by reference herein in its entirety.

### BACKGROUND

1. Field of Invention

The present invention relates to a touch pad module. More particularly, the present invention relates to a touch pad module for a notebook computer.

2. Description of Related Art

Since Microsoft windows system is used to operate a personal computer, controlling an operation system by a mouse becomes essential. A notebook computer usually has a touch pad module thereon, instead of a mouse.

A conventional notebook, equipped with a metal housing (such as an aluminum alloy), may also include metal click buttons. As a result of the elastic characteristics of metal, metal click buttons provide recovery forces by the elasticity of themselves. The metal click buttons, which are operated as a general mouse is, are clicked with high frequency so as to control a Windows operation system.

High frequency repeated click actions are known to cause metal fatigue in metal click buttons. Surfaces of metal click buttons thus become creased and no longer provide a suitable and comfortable sense of touch.

### SUMMARY

The objective of the present invention provides a touch pad module with a suitable and comfortable sense of touch.

In accordance with the foregoing objective, a touch pad module having a click plate is disclosed. In order to provide a more comfortable and suitable sense of touch, a plastic member is attached under the click plate. The plastic member includes a frame portion and a button portion. The frame portion has a square opening for exposing a touch pad. The button portion is connected with the frame portion by a rib and a suspension arm. The suspension arm includes a U-shaped spring section. The touch pad is positioned under the plastic member and aligned with the square opening. The touch pad module further includes a flexible printed circuit to convert click actions into signals and to transmit the same to a motherboard of a notebook computer. The switch is installed on the flexible printed circuit to convert click actions received from button portions into signals. A bracket is assembled with the plastic member to sandwich the flexible printed circuit and the touch pad.

Thus, a click action becomes suitable and comfortable by attaching a plastic member under the metal click plate. In an embodiment of the invention, the plastic member includes a suspension arm to support its button portions. Moreover, a U-shaped spring section of the suspension arm provides a suitable and comfortable click action.

It is to be understood that both the foregoing general description and the following detailed description are examples, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention, and, together with the description, serve to explain the principles of the invention. In the drawings,

FIG. 1 is a schematic, exploded view of a touch pad module according to one preferred embodiment of this invention;

FIG. 2 is a schematic, top view of a touch pad module according to one preferred embodiment of this invention; and

FIG. 3 is a schematic, side view of a plastic member according to one preferred embodiment of this invention.

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

The embodiment of the present invention provides a inventive touch pad module. By attaching a plastic member under the metal click plate, a click action becomes suitable and comfortable. The plastic member includes a U-shaped spring section to provide a suitable and comfortable elastic force.

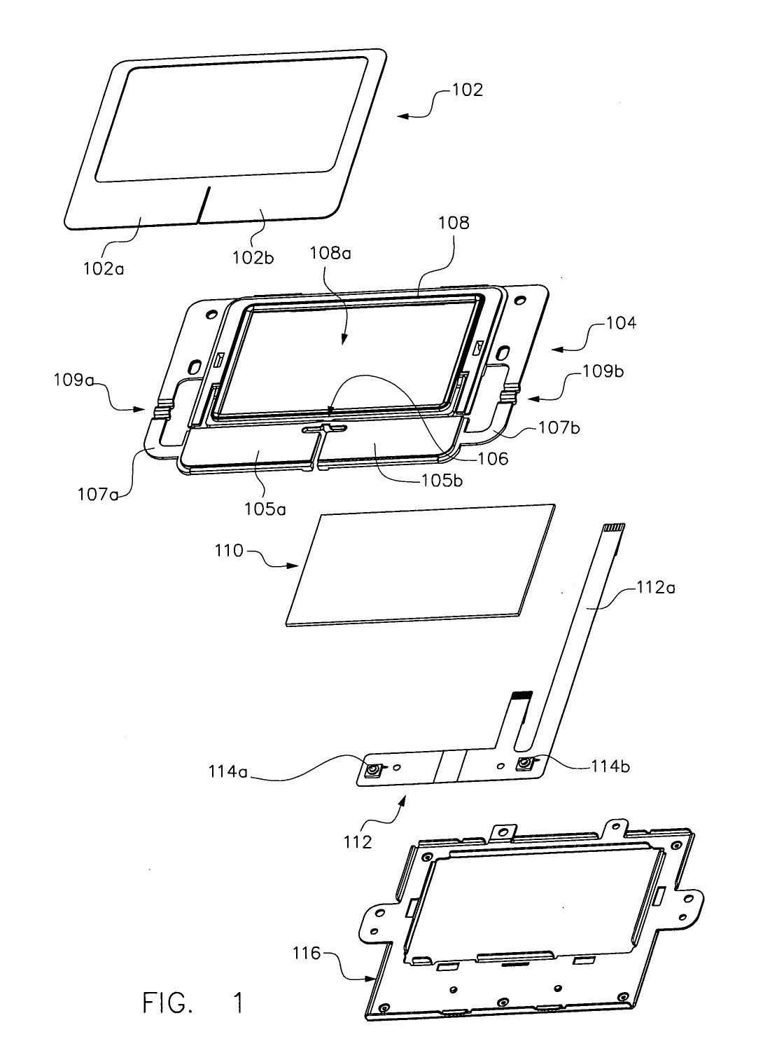

FIG. 1 is a schematic, exploded view of a touch pad module according to one preferred embodiment of this invention. A user can click buttons 102a and 102b of a metal click plate 102 to control an operation system of a notebook computer. In order to provide a more comfortable and suitable click action, a plastic member 104 is attached under the metal click plate 102. The plastic member 104 includes a frame portion 108 and button portions 105a and 105b. The frame portion 108 has a square opening 108a for exposing a touch pad 110 positioned under the square opening 108a. Each button portion is connected with the frame portion by a rib and a suspension arm. For instance, the button portion 105a is connected with the frame portion 108 by the rib 106 and the suspension arm 107a; the button portion 105b is connected with the frame portion 108 by the rib 106 and the suspension arm 107b. The suspension arms 107a and 107b respectively have spring sections 109a and 109b. Because a rib and a suspension arm only support a button portion, metal buttons 102a and 102b, which are respectively supported by button portions 105a and 105b, have comfortable and suitable click actions. The touch pad 110 is positioned under the plastic member 104 and aligned with the opening 108a. The touch pad module further includes a flexible printed circuit 112 to convert click actions into signals and to transmit them to a motherboard of a notebook computer. Two switches 114a and 114b are installed on the flexible printed circuit 112 to convert click actions of button portions 105a and 105b into signals. Thus, two switches 114a and 114b need to be positioned under button portions 105a and 105b in order to receive click actions. Signals, converted by switches 114a and 114b, are transmitted by the flexible printed circuit 112 to the motherboard of a notebook computer (not illustrated in drawings). A bracket 116 is assembled with the plastic member 104 to sandwich the flexible printed circuit 112 and the touch pad 110.

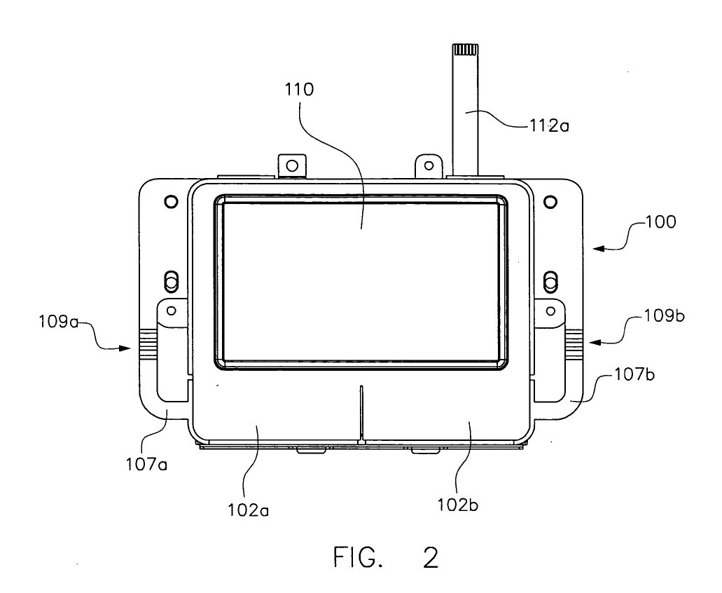

FIG. 2 is a schematic, top view of a touch pad module according to one preferred embodiment of this invention. FIG. 2 is the assembly result of all components in FIG. 1. The touch pad module 100 can be properly mounted on a notebook computer. When a user presses buttons 102a and 102b, spring sections 109a and 109b of suspension arms 107a and 107b provide recovery forces. Signals, generated by buttons 102a and 102b, are transmitted by the flexible printed circuit 112 to the motherboard of the notebook computer (not illustrated in drawings).

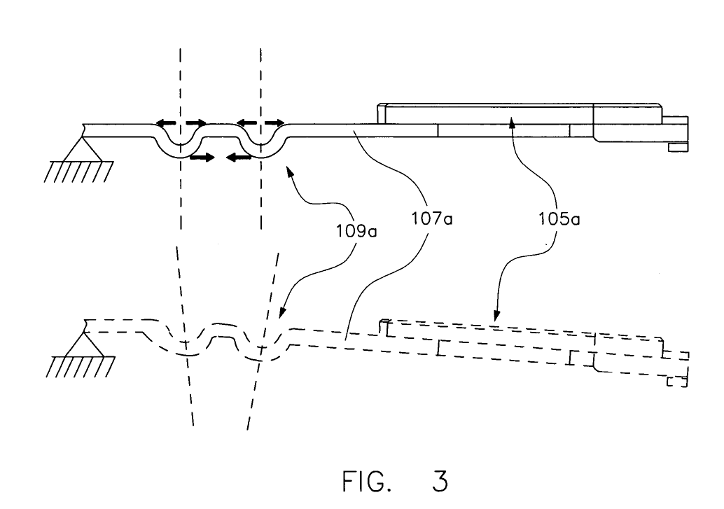

FIG. 3 is a schematic, side view of a plastic member according to one preferred embodiment of this invention. The spring section 109a of the suspension arm 107a is the key component to provide a comfortable and suitable click action. The U-shaped spring section 109a, the frame portion 108 and the button portion 105a are manufactured as only one plastic element. When button portion 105a is pressed, most deformations occur on the U-shaped spring section 109a. The U-shaped spring section 109a provides a comfortable and suitable click action. Although the spring section 109a is composed of two U-shaped springs in this preferred embodiment, present invention does not limit U-shaped spring's quantity. Areas of button portion 105a and materials of suspension 107a may affect U-shaped spring's quantity.

According to preferred embodiments, a click action becomes suitable and comfortable by attaching a plastic member under the metal click plate. The plastic member includes a suspension arm to support its button portions. An U-shaped spring design of the suspension arm provides a suitable and comfortable click action.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A plastic member, providing an elastic recovery force for a touch pad module of a notebook computer, said touch pad module having a click plate, said plastic member comprising:
a frame portion; and
a button portion, positioned under said click plate, said button portion including a rib and a suspension arm connected with said frame portion to provide said click plate with a elastic recovery force, wherein said suspension arm includes a spring section.

2. The plastic member of claim 1, wherein said spring section includes a U-shaped spring.

3. The plastic member of claim 2, wherein said U-shaped spring, said frame portion and said button portion are manufactured as one plastic element.

4. A touch pad module, comprising:
a metal click plate;
a plastic member, attached under said metal click plate, said plastic member comprising:
a frame portion, having an opening; and
a plurality of button portions, positioned under said click plate, each of said button portions including a rib and a suspension arm connected with said frame portion to provide said click plate with a recovery force, wherein said suspension arm includes a spring section;
a touch pad, positioned under said plastic member and aligned with said opening; and
a flexible printed circuit, positioned under said plastic member, said flexible printed circuit having a plurality of switches disposed under said button portions, wherein when said metal click plate is pressed by a user, said button portions are thus pressed to push said switches, and signals generated by said switches are transmitted by said flexible printed circuit.

5. The touch pad module of claim 4, further comprising a bracket assembled with said plastic member to sandwich said touch pad and said flexible printed circuit.

6. A touch pad module, comprising:
a metal click plate; and
a plastic member, attached under said metal click plate, said plastic member comprising:
a frame portion, having an opening; and
a plurality of button portions, positioned under said click plate, each of said button portions including a rib and a suspension arm connected with said frame portion to provide said click plate with a recovery force, wherein said suspension arm includes a spring section.

7. The touch pad module of claim 6, further comprising a touch pad, attached under said plastic member and aligned with said opening.

8. The touch pad module of claim 7, further comprising a flexible printed circuit positioned under said plastic member, said flexible printed circuit having a plurality of switches disposed under said button portions, wherein when said metal click plate is pressed by a user, said button portions are thus pressed to push said switches, and signals generated by said switches are transmitted by said flexible printed circuit.

9. The touch pad module of claim 8, further comprising a bracket assembled with said plastic member to sandwich said touch pad and said flexible printed circuit.
